(19) United States
(12) Patent Application Publication
(10) Pub. No.: US 2020/0109913 A1
(43) Pub. Date: Apr. 9, 2020

(54) GUN RAIL-MOUNTED BADGE SYSTEM AND METHOD OF USE

(71) Applicant: Robert L. Hanson, Anacortes, WA (US)

(72) Inventor: Robert L. Hanson, Anacortes, WA (US)

(21) Appl. No.: 16/151,231

(22) Filed: Oct. 3, 2018

(51) Int. Cl. F41C 27/00; G09F 3/08

(52) U.S. Cl. CPC F41C 27/00; G09F 3/08

(57) ABSTRACT

A gunrail badge mount system includes a mount base having a mount socket, coupleable to a mounting bracket of a gunrail system. A badge element includes a badge plate configured to receive a marking thereon and a mounting boss sized and configured to be received into the mounting socket and hold the badge plate at a selected position and orientation relative to the mount base. The mounting boss includes an indexing element configured to engage a corresponding indexing feature of the mount socket while the badge plate is at the selected position and orientation relative to the mount base.

### RELATED APPLICATIONS

This application claims the benefit of U.S. Provisional Patent Application Ser. No. 62/606,707 filed on Oct. 3, 2017.

### BACKGROUND

### Technical Field

The present disclosure is related to systems for attaching accessories to firearms, and in particular to systems for attaching decorative or informative graphics to standardized gun rail brackets

### Description of the Related Art

A gun rail is a bracket that is attached to a firearm, such as a rifle or handgun, for the purpose of attaching accessories, such as scopes, lasers, lights, etc. to the firearm. The rail portion is standardized while rail clamps are manufactured in a variety of configurations and with various fastening elements, depending on the type of firearm and the particular accessory to be mounted. Many firearms are provided with multiple gunrail brackets in the factory, while aftermarket gunrail systems are available for retrofitting firearms that are not so equipped initially.

### SUMMARY OF THE INVENTION

According to an embodiment, a gunrail badge mount system is provided, that includes a mount base configured to be attached to a mounting bracket of a gunrail system, and a badge element configured to be coupled to the mount base. The mount base includes a mounting socket, while the badge element includes a badge plate configured to receive a marking thereon, and a mounting boss sized and configured to be received into the mounting socket and to hold the badge plate at a selected position and orientation relative to the mount base.

According to an embodiment, the mounting boss includes an indexing element configured to engage a corresponding indexing feature of the mounting socket while the badge plate is at the selected position and orientation relative to the mount base.

According to an embodiment, the badge plate is sized and configured to receive a standard dog tag thereon.

### BRIEF DESCRIPTION OF THE DRAWINGS

FIG. 1 is a perspective view of a gunrail badge assembly, according to an embodiment, including a gunrail mount and a badge element;

FIGS. 2 and 3 are views, respectively, of the gunrail mount and the badge element, from other perspectives;

FIG. 4 is a top plan view of a gunrail mount base showing an alternate configuration according to an an embodiment;

FIG. 5 shows a firearm equipped with gunrails, on one of which is mounted a gunrail badge assembly, according to an embodiment;

FIG. 6 is a perspective view of a gunrail badge assembly, according to another embodiment;

FIG. 7 is an exploded view of the gunrail badge assembly of FIG. 6;

FIGS. 8-10 are perspective views of a gunrail badge assemblies configured to receive standard military issue-type dog tags, or similarly shaped badges, according to respective embodiments;

FIG. 11 is an exploded view of a gunrail badge assembly, according to an embodiment;

FIG. 12 is a perspective view of a gunrail badge assembly, according to another embodiment; and

FIG. 13 is a chart showing a partial selection of badge plate profiles that can be used with gunrail badge assemblies, according to respective embodiments.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

The term gunrail is used herein to refer to any of a number of standardized accessory mounting systems that employ brackets configured to be attached to firearms, and to receive accessories such as telescopic sights, lights, tripods, bipods, hand grips, etc. Examples of gunrail systems include: Picatinny Rail (MIL-STD-1913), Weaver Rail, NATO Accessory Rail, KeyMod, M-LOK, etc.

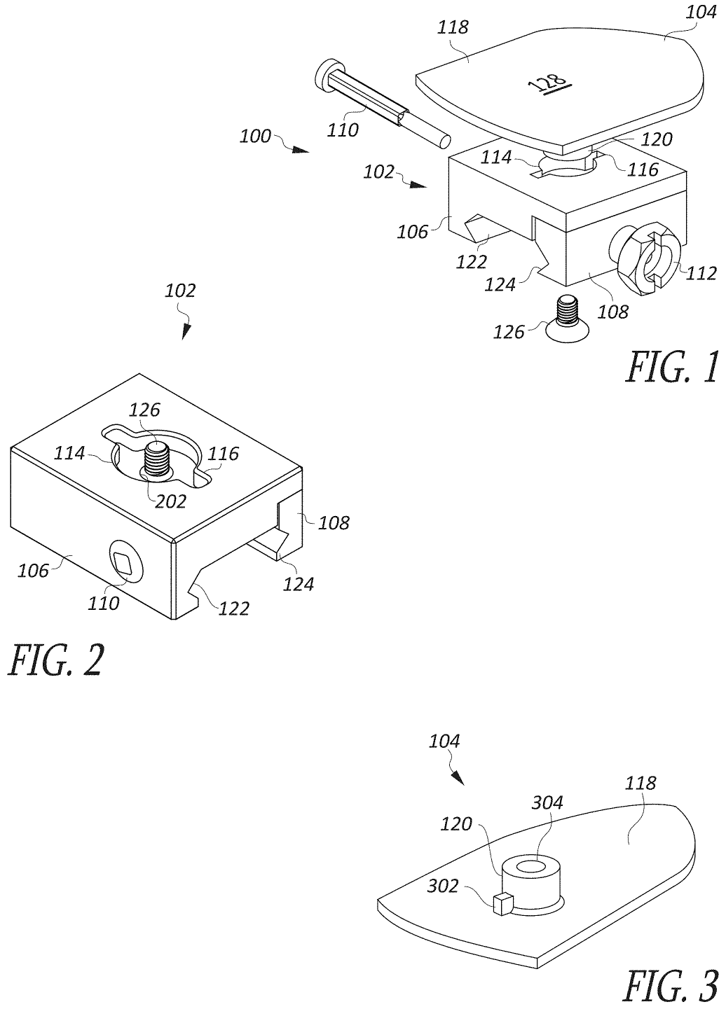

FIG. 1 is a perspective view of a gunrail badge assembly 100, according to an embodiment. The badge assembly 100 includes a gunrail mount 102 and a badge element 104. FIGS. 2 and 3 are, respectively, views of the gunrail mount 102 and the badge element 104, from other perspectives. The gunrail mount 102 comprises a mount base 106, a clamp plate 108, a clamp screw 110, and a clamp nut 112. The mount base 106 also includes a mount socket 114 with alignment notches 116. The badge element 104 includes a badge plate 118 with a boss 120, on a lower surface, configured to be received into the mount socket 114 of the mount base 106.

The gunrail mount 102 is configured to attach to a standard gunrail system, such as one of those listed above. The example shown in FIG. 1 is configured to be attached to a Picatinny Rail system. Other embodiments are also envisioned, configured to be attached to various alternative gunrail systems. The mount base 106 and the clamp plate 108 include respective clamping jaws 122, 124 sized and configured to lock the gunrail mount 102 to a Picatinny Rail bracket by engaging opposite sides of the bracket. The clamp screw 110 passes through apertures in the mount base 106 and the clamp plate 108 so that rotation of the clamp nut 112 on the clamp screw tightens (or loosens) the engagement of the bracket by the jaws. The apertures are positioned such that a square shank of the clamp screw 110 passes through one of a plurality of transverse slots—which are standard elements of the Picatinny Rail system—thereby locking the gunrail mount 102 in position, longitudinally.

A badge attachment screw 126 is provided, configured to pass through an aperture 202 in the mount socket 114 from below and couple the badge element 104 to the gunrail mount 102. An upper surface 128 of the badge element 104 is configured to be marked or decorated according to a user's requirements. For example, the upper surface 128 may include a patriotic or team motif, a marking that identifies an owner of a firearm to which the gunrail badge assembly 100 is attached, a marking indicating a military rank of the owner, a marking differentiating one firearm from among a plurality of similarly configured firearms, etc. A shape of the badge plate 118 can be selected according to an intended use or marking, etc. In the embodiment shown in FIGS. 1-3, the badge plate has a shield shape. Embodiments in which the badge plate has various other shapes will be described in more detail later.

Referring in particular to FIG. 3, which shows a perspective of the badge element 104 from below, the boss 120 can be seen in greater detail. The boss 120 includes one or more indexing guides 302 and a screw aperture 304. The indexing guides 302 are configured to be received into corresponding alignment notches 116 of the mount socket 114 to control the orientation of the badge element 104 relative to the gunrail mount 102 and the firearm to which it may be attached. The screw aperture 304 is configured to receive the badge attachment screw 126 to attach the badge element 104 to the gunrail mount 102. According to an embodiment, the interior of the screw aperture 304 is threaded to receive the badge attachment screw 126. According to another embodiment, the screw aperture 304 includes a threaded insert configured to receive the badge attachment screw 126 (see, e.g., FIG. 7).

Components of the gunrail badge assembly 100 can be made of any appropriate material, such as, for example, stainless or carbon steel, tempered aluminum, brass, nylon, acetal plastic, etc. According to an embodiment, the mount base 106 and clamp plate 108 are hardened 6061aluminum, anodized with a matte black finish, the clamp screw 110, the clamp nut 112, and the badge attachment screw 126 are 304 stainless steel, with a matte black oxide finish, and the badge element 104 is glass-reinforced black nylon, with a threaded insert configured to receive the badge attachment screw.

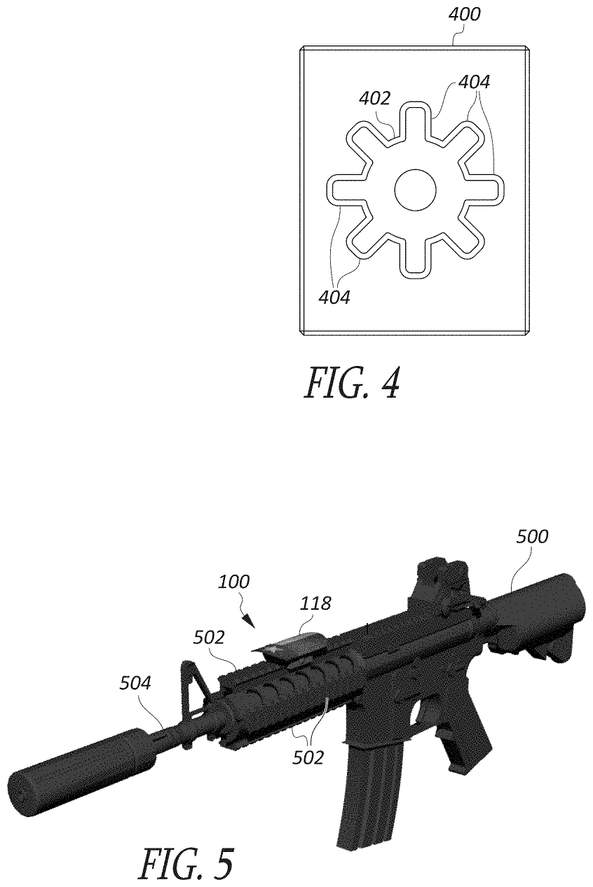

FIG. 4 is a top plan view of a mount base 400 according to an alternative embodiment. The mount base 400 is substantially identical to the mount base 106 in most respects. However, the mount base 400 comprises a mount socket 402 that includes a plurality of alignment notches 404, which enables the badge element 104 to be selectively positioned in a variety of orientations.

FIG. 5 shows a firearm 500 equipped with gunrails 502 on the top, bottom, and sides of the barrel. A gunrail badge assembly 100 is attached to the gunrail 502 on the top of the barrel 504. Of course, the badge assembly can be attached at any position, longitudinally, to any of the gunrails 502. The example of FIG. 5 shows the gunrail badge assembly 100 attached to an M4 military carbine, but of course, the assembly can be attached to any firearm, or other device, that is equipped with a compatible gunrail system, including, for example, sport rifles, shotguns, hand guns, paintball, airsoft or laser tag guns, etc.

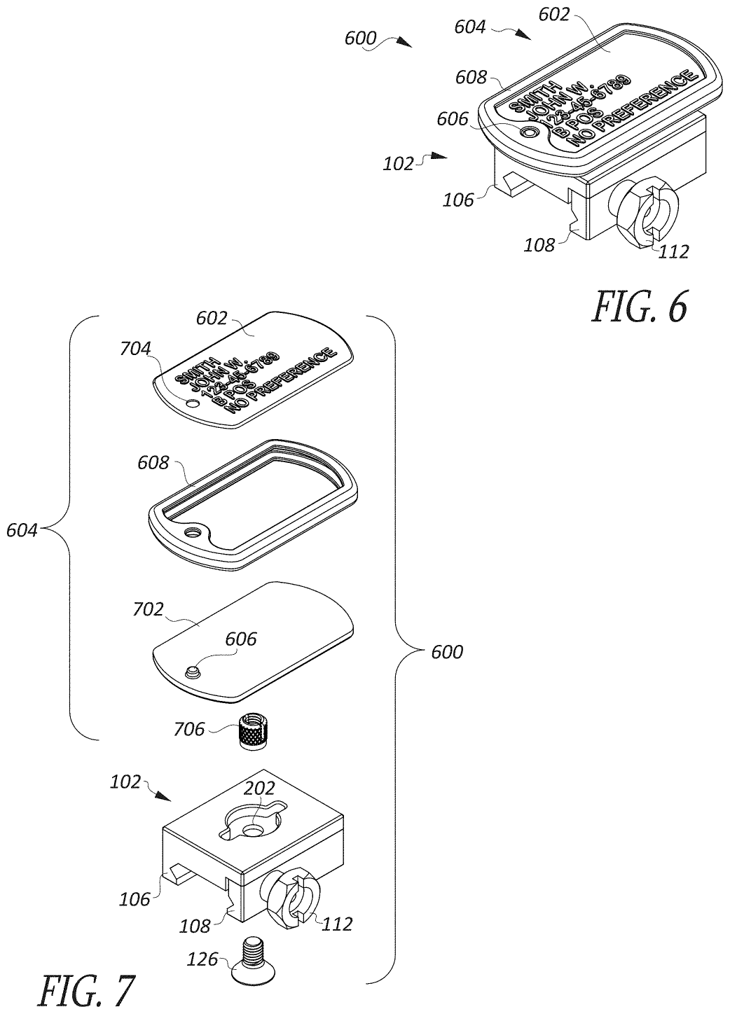

FIG. 6 is a perspective view of a gunrail badge assembly 600, according to another embodiment, and FIG. 7 is an exploded view of the gunrail badge assembly 600. The gunrail badge assembly 600 is configured to receive a standard military issue-type dog tag 602, or similarly shaped badge. The badge assembly 400 employs a gunrail mount 102 similar to that described with reference to the embodiment of FIGS. 1-3. A badge element 604 includes a badge plate 702 that substantially matches, in shape and size, the dimensions and shape of the standard dog tag 602, and alocating pin 606 is attached to the badge plate in a position that corresponds to the position of the chain hole 704 of the dog tag. Also provided, as part of the badge element 604 is a standard dog tag silencer 608, which is an elastomeric gasket that is typically used to prevent dog tags from jangling together when worn around the neck of an individual. A user positions the dog tag 602 on the badge plate 702 with the locating pin 606 extending into the chain hole 704 of the dog tag. While holding the dog tag 602 and the badge plate 702 in this position, the user positions the dog tag silencer 608 over the rims of the dog tag and badge plate, thereby securing the dog tag to the badge element 604. The badge element 604 is then coupled to the gunrail mount 102, the attachment screw 126 engaging the boss 120. A threaded insert 706 is shown in FIG. 7, which can be employed in embodiments in which the material of the badge element 604 is softer, such as, e.g., nylon, to prevent screw threads in the boss 120 from wearing out, over time.

According to another embodiment, an adhesive, such as, e.g., a piece of pressure sensitive tape, is positioned on the badge plate 702, and by which the user attaches the dog tag 602 to the badge plate, obviating the need for the silencer 608. In embodiments in which the dog tag 602 is attached via adhesive, the badge plate 702 need not have dimensions that correspond to those of the dog tag. Instead, the badge plate 702 can be smaller (or larger) than the dog tag.

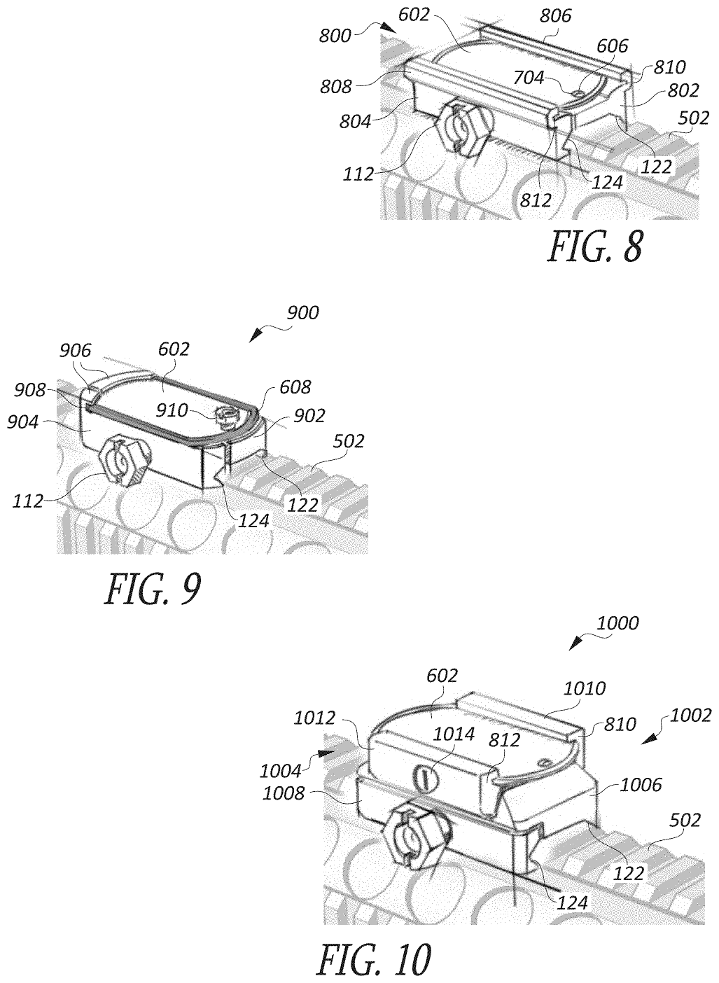

FIGS. 8-10 are perspective views of gunrail badge assemblies 800, 900, 1000 configured to receive standard military issue-type dog tags, or similarly shaped badges, according to respective embodiments.

The gunrail badge assembly 800 of FIG. 8 includes a mount base 802 and clamp plate 804, with respective clamping jaws 122, 124 sized and configured to lock the gunrail mount 102 to a Picatinny Rail bracket 502, substantially as described above with reference to other embodiments. However, the mount base 802 and clamp plate 804 also include respective badge engagement jaws 806, 808, but also the badge engagement jaws 806, 808. The badge engagement jaws 806, 808 include respective engagement channels 810, 812 configured to engage opposite edges of the dog tag 602.

According to an embodiment, to mount a dog tag to a gunrail 502, a user positions the badge assembly 800 on the gunrail with the clamp nut 112 loosely engaging the clamp screw. The user then slides the dog tag 602 between the badge engagement jaws 806, 808 until the dog tag is longitudinally centered in the jaws. The use then tightens the clamp screw, which simultaneously closes the clamping jaws 802, 804 and the engagement jaws 806, 808, locking the gunrail badge assembly 800 to the gunrail 502 and the dog tag 602 to the assembly.

According to an embodiment, the apertures in the mount base 802 and clamp plate 804 through which the clamp screw 110 passes are slightly oversized. Additionally, the clamp screw 110, clamp nut 112 and corresponding contact surfaces on the mount base 802 and clamp plate 804 are configured to permit a small amount of relative rotation of the mount base and clamp plate. When the clamp nut 112 is tightened, drawing the mount base 802 and clamp plate 804 together, the clamping jaws 802, 804 may contact the gunrail 502 either before or after the engagement jaws 806, 808 contact the edges of the dog tag 602, generally because of small variations in the dimensions of small variations in the dimensions of dog tags manufactured at different times and by different manufacturers. When this occurs, the mount base 802 and clamp late 804 rotate with respect to each other, as the clamp nut is further tightened, until both the clamp jaws 802, 804 and the engagement jaws 806, 8080 are in firm contact.

According to another embodiment, the engagement channels 810, 812 in one or both of the badge engagement jaws 806, 808 are tapered, becoming slightly narrower as they deepen. When the engagement jaws 806, 808 are tightened to engage the dog tag 602, the engagement channels 810, 812 grip the edges of the dog tags and the edges are pressed towards the backs of the channels where they become narrower than the thickness of the dog tags, providing a secure and reliable engagement.

The gunrail badge assembly 900 of FIG. 9 includes a mount base 902 and clamp plate 904, with respective clamping jaws 122, 124 sized and configured to lock the gunrail mount 102 to a Picatinny Rail bracket 502. One or both of the clamping jaws 122, 124 includes a badge bracket 906 with an engagement channel 908 sized to snugly receive the edge of a dog tag 602 and silencer 608. A retaining screw 910 extends through the chain hole 704 of the dog tag 602, cooperating with the badge bracket 906 to securely hold the dog tag in place.

The gunrail badge assembly 1000 of FIG. 10 includes a gunrail mount 1002 and a badge mount 1004. The gunrail mount 1002 includes a mount base 1006 and clamp plate 1008, with respective clamping jaws 122, 124 sized and configured to lock the gunrail mount 102 to a Picatinny Rail bracket 502. The badge mount 1004 includes first and second badge clamps 1010, 1012 with respective badge engagement jaws 810, 812. A badge engagement screw 1014 extends through apertures in the first and second badge clamps 1010, 1012, and also through an aperture in an upper portion of the mount base 1006, coupling the badge mount 1004 to the gunrail mount 1002. Accordingly to an embodiment, a badge clamping nut is positioned to engage the badge engagement screw 1014. Rotation of the badge clamping nut tightens or loosens the first and second badge clamps 1010, 1012. According to another embodiment, the aperture extending through the first badge clamp 1012 is threaded to receive the badge engagement screw 1014.

According to an alternate embodiment, the first badge clamp 1012 is integral with the mount base 1006, so that only the badge clamp 1014 moves with respect to the gunrail mount 1002 when the badge engagement screw 1014 is rotated.

It can be seen that the gunrail badge assembly 1000 of FIG. 10 is similar in many respects to the gunrail badge assembly 800 of FIG. 8. However, they differ, in particular, in that the badge assembly 800 employs a single fastener to engage both the gunrail 502 and the dog tag 602, while the badge assembly 1000 employs separate fasteners for these purposes.

The various embodiments described with reference to FIGS. 6-10 are configured to couple a standard U.S. military issue-type dog tag to a gunrail system and are provided as examples. Other embodiments are contemplated, in which similar gunrail badge assembles are configured for use with badges or tags of other dimensions.

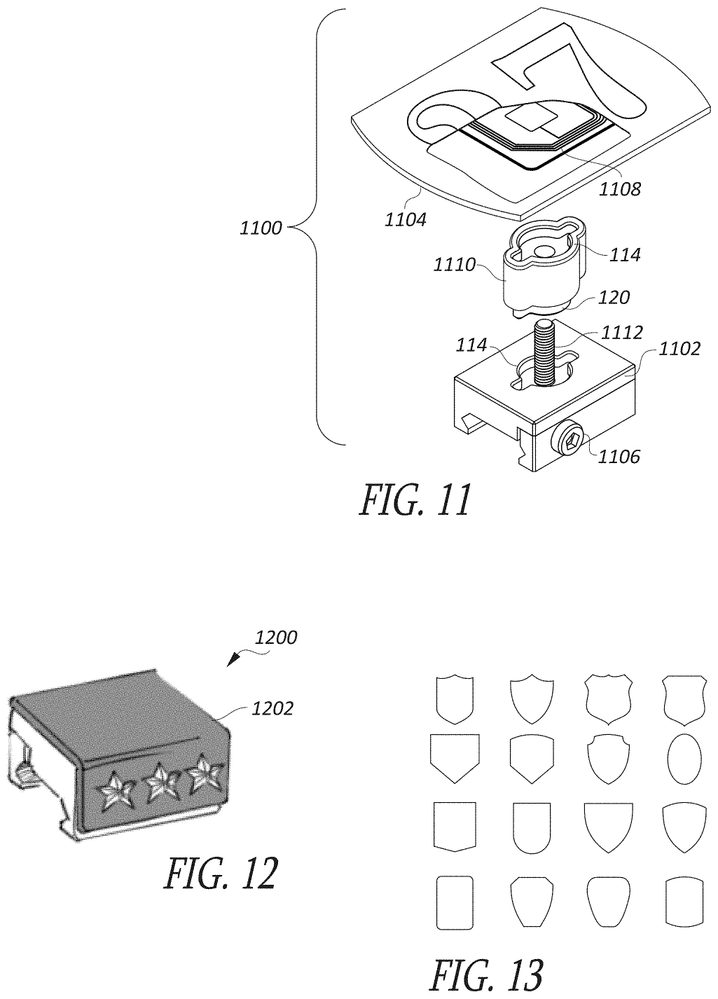

FIG. 11 is an exploded perspective view of a gunrail badge assembly 1100, according to an embodiment. The inventor contemplates the use of gunrail badge assemblies in establishments that rent or loan firearms to patrons for use on the premises. For example, many businesses that operate paintball or airsoft ranges and courses have loaner guns available for the use of patrons who do not bring guns of their own. In such cases, markings on badge plates attached to the loaner guns can be used to identify those guns as belonging to the facility.

The badge assembly includes a gunrail mount 1102 and a badge element 1104. The gunrail mount 1102 is similar in most respects to many other gunrail mounts described above, but also includes a clamp nut 1106 that is not easily tightened or loosened except by the use of a specialized tool, and that resists removal by unauthorized persons.

The badge element 1104 is shown with a portion cut away to show an RFID tag 1108 embedded therein, configured to be detected by RFID sensors positioned near exits of facilities that make loaner guns available. The markings on the badge element 1104, the RFID tag 1108 and the clamp nut 1106 serve to enhance the security of the firearm to which some or all are attached. The markings enable a range owner to recognize at a glance weapons that are the property of the establishment; the RFID tag enables detection of a weapon as it passes near an RFID detector, even if the weapon is hidden or covered, and the clamp nut resists removal of the device, making it more difficult for a would-be thief to steal the weapon.

Many of these features can be useful in other contexts as well. For example, an armorer can use them to easily identify and track specific weapons in an inventory and to quickly distinguish between them, or in situations in which firearms belonging to multiple owners are held or stored together.

According to other embodiments, the RFID tag 1108 is configured to store data specific to the firearm to which it is mounted. Such data can include, for example, names and information relating to individuals to whom the associated firearm is or has been assigned or rented, maintenance history, ownership information, etc. Embodiments incorporating other types of tags, sensors or processors are also contemplated, such as, for example, tracking devices (e.g., GPS), alternative signaling devices for use with cell phone apps, etc., sensors configured to detect firing of the gun, processors configured to count and record shots fired, sensors configured to detect, record and/or display data relating to ambient conditions during use, etc. Embodiments may also be provided to display handwritten or digitally entered shooter information, e.g., a paper, grease pencil or electronic display, as for long range shooting data, for example.

The gunrail badge assembly 1100 is also shown as including an extender element 1110, configured to support the badge element 1104 at an increased distance from the gunrail bracket. The extender element 1110 includes a mount socket 114 configured to receive a boss positioned on the back of the badge element 1104 and also includes a boss 120 configured to be received into the mount socket 114 of the mount base 1102. A long badge attachment screw 1112 is sized to extend through the extender element to engage the boss of the badge element 1104. The extender element 1110 might be used, for example, where the badge element 1104 might otherwise interfere with proper operation of the firearm, or with the placement or operation of other accessories mounted to the gunrail system.

According to an embodiment, a long boss is provided, configured to support a badge element at a selected elevation above a mount base without requiring a separate extender element.

FIG. 12 is a perspective view of a gunrail badge assembly 1200, according to another embodiment, and includes a mount base 1202 and a badge plate 1204. In the embodiment of FIG. 12, a clamp screw and clamp nut are configured to recess into respective countersink apertures on the sides of the mount base 1202, so there is no feature that protrudes beyond the side surfaces of the base. The badge plate 1204 is configured to wrap around and cover three sides of the mount base 1202, with lips 1206 along some or all of the edges of the badge plate configured to engage the corners of the mount base. To install, a user first secures the mount base to the gunrail, then presses the badge plate over the mount base. The badge plate 1204 resiliently flexes outward as it is being attaches, until the lips 1206 snap over the corners, securing the badge plate to the base 1202. This embodiment permits graphics or decorations to be applied to multiple faces of the badge assembly 1200.

FIG. 13 is a diagrammatic plan view showing various examples of profile shapes that can be applied to badge plates, according to respective embodiments. While there are other known systems for attaching decorations and marking to firearms via gunrail systems, deficiencies have been recognized with respect to some of these systems. For example, know systems impose limitations on the size and orientation of a graphics element that is to be mounted to a firearm. Referring to the present disclosure, it will be noted that, according to many of the embodiments, the shape and size of the badge plate is not constrained by the size or shape of the underlying gunrail mount. The badge plate can be much larger (or smaller) than gunrail mount to which it is attached, or can be contoured according to criteria unrelated to the mounting system. For example, referring to the embodiment described with reference to FIG. 5, it can be seen that the badge plate 118 has an arcuate contour selected to compliment the shield motif of the markings, while the badge plate 702 of the embodiment described with reference to FIGS. 6 and 7 is flat, to conform to the shape of the dog tag 602. In both examples, the dimensions of the respective badge plates are greater than those of the underlying gunrail mount 102, and the orientation is defined by the positions of the indexing guides. In each case, it is only necessary that the boss be dimensioned to provide sufficient clearance for the selected contour relative to the upper surface of the rail and, if necessary, an indexing guide positioned to establish and maintain a desired orientation. This is in contrast to many known marking systems, in which images or markings are essentially framed by the corresponding mounting elements, and are thus constrained to those dimensions, and to a single orientation.

Additionally, according to some embodiments, a badge mount assembly can provide some additional protection to a firearm. For example, many of the embodiments include a badge element that is reinforced nylon, which has a degree of resiliency. The badge element can therefore protect portions of a firearm in the case of an unintended drop or fall, or when the weapons are being stacked together which might otherwise result in misalignment of the sights or breakage of sensitive parts or accessories. In such instances, the flexibility of the material in combination with the space beneath the flange-like edge of the badge element allows the latter to deflect resiliently upon impact so as to reduce the intensity of the shock that is transferred to the weapon and associated optics/accessories. The edges of the flanges may be extended and/or provided with particular shapes, projections, contours or other features to enhance the degree of impact protection, and similarly the mounting boss or post may be increased or otherwise adjusted in height and/or provided with or formed of a shock absorbing feature or material to enhance its performance in this respect.

Another benefit of the present system is that graphics or other features that are attached to a firearm via a gunrail badge mount assembly can be easily changed or removed. This is in contract to markings that a gun owner might apply directly to a firearm, such as with paint or engraving or a plate attached to the firearm with screws or the like.

The abstract of the present disclosure is provided as a brief outline of some of the principles of the invention according to one embodiment, and is not intended as a complete or definitive description of any embodiment thereof, nor should it be relied upon to define terms used in the specification or claims. The abstract does not limit the scope of the claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system, comprising:
a mount base configured to be coupled to a mounting bracket of a gunrail system and having a mount socket; and
a badge element, including:
a badge plate configured to receive a marking thereon, and
a mounting boss affixed to the badge plate, sized and configured to be received into the mount socket and hold the badge plate at a selected position and orientation relative to the mount base.

2. The system of claim 1, wherein the mounting boss includes an indexing element configured to engage a corresponding indexing feature of the mount socket while the badge plate is at the selected position and orientation relative to the mount base.

3. The system of claim 2, wherein the mount socket includes a plurality of indexing features configured to receive the indexing element of the mounting boss at any of a plurality of selected orientations.

4. The system of claim 1, wherein the badge plate is configured to have a standard military dogtag affixed thereto.

5. The system of claim 4, wherein the badge plate includes an alignment pin in a position that corresponds to a chain hole of a standard military dog tag.

6. The system of claim 4, wherein the badge element includes a dog tag silencer positioned over a rim of the badge plate.

7. The system of claim 1, wherein dimensions of the badge plate are greater than those of the mount base in at least two axes.

8. The system of claim 1, wherein a contour of the badge plate does not conform to a contour of an upper face of the mount base.

9. The system of claim 1, comprising an extender element configured to be coupled between the mount base and mounting boss, and to increase a distance at which the badge plate is held from the mount base.
